(19) United States
(12) Patent Application Publication
(10) Pub. No.: US 2020/0250271 A1
(43) Pub. Date: Aug. 6, 2020

(54) User Prediction Statement Generation System

(71) Applicant: Maurence Anguh, Chicago, IL (US)

(72) Inventor: Maurence Anguh, Chicago, IL (US)

(21) Appl. No.: 16/266,056

(22) Filed: Feb. 2, 2019

(51) Int. Cl. G06F 17/27

(52) U.S. Cl. CPC G06F 17/2785; G06F 17/2735; G06F 17/271

(57) ABSTRACT

A User Prediction Statement Generation System is presented. This system segments an event into sub-events recursively using the event discrete time series. The segmented is represented as a k-ary tree with the root node as the entire event, and child nodes as sub-events until the leaf nodes with the event unit time duration. A natural language processing method with the event dictionary and syntax is incorporated at each node of the k-ary tree. A user utilizes a device to input the event prediction parameters via voice, keyboard or k-ary tree graphical user interface ((GUI). The system utilizes the user prediction parameters to traverse the event k-ary tree to the appropriate node, and the node natural language processing method to parse the user prediction parameters and create a valid user prediction statement for prediction markets, crowdsourcing or betting. This main advantages of this invention are: 1) real time user generation of simple and compound prediction statements for events and sub-events; 2) granularity and completeness allowing creation of all possible natural language prediction statements for an event and sub-event; 3) natural language processing methods to ensure user generation of valid prediction statements; 4) Flexibility in generating prediction statements before or during an event; and 5) Openness to integration with existing intelligent tools for prediction markets, crowdsourcing and betting.

### CROSS-REFERENCE TO RELATED APPLICATIONS

Not Applicable

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFSWEB)

Not Applicable.

### STATEMENT REGARDING PRIOR DISCLOSURES BY THE INVENTOR OR A JOINT INVENTOR

Not Applicable.

### BACKGROUND OF THE INVENTION

### Field of the Invention

This invention relates to a User Prediction Statement Generation System. This system segments an event E into Sub-events Σₜ₌ₛⁿ, Et using the event discrete time series t, and represents the event as a k-ary tree Π(Σₜ₌ₛⁿ Et). A natural language processing method Ω[Π(Σₜ₌ₛⁿEt)] of the event dictionary and syntax is incorporated at each node of the k-ary tree to enable the user generate real time natural language event prediction statements for prediction markets, crowdsourcing or betting.

### Background Art

An event can be segmented into sub-events using the event discrete time-series, and sub-events can be recursively segmented into smaller sub-events until the event unit time. Let E denote an event, then we can segment an event as follows:

E=Σₜ₌ₛⁿEt; where Eₜ is a sub-event; t is the event time series; s is the event start time; n is the event end time and n>s. Therefore an event E can be represented by sub-events Eₜ as follows:

$$E = {Σ}_{t = s}^{s + μ} Et + {Σ}_{t = s + μ}^{s + 2 μ} Et + … + {Σ}_{t = n - μ}^{n} Et ; where μ > 0 is u > 0 is the event unit time ; = \\ = {E}_{μ} + {E}_{μ} + … + {E}_{μ} ; = {Σ}_{μ = s}^{k μ} E μ + {Σ}_{μ = k μ}^{p μ} E μ + … + {Σ}_{u = p μ}^{n} E μ ; where k > 0 and p > 0.$$

Thus an event can be segmented using the event discrete time series into sub-events of equal or different durations based on the event unit time.

The segments of the event can be represented by a k-ary tree where the root node is the whole event and child nodes are sub-events respectively.

Let π denote a k-ary tree, then we can represent the event as follows:

$$E = {Σ}_{t = s}^{n} Et ;$$

$$Π ( E ) = Π ( {\sum }_{t = s}^{n} Et ) ; = Π ( {Σ}_{t = s}^{s + μ} Et ) + Π ( {Σ}_{t = s + μ}^{s + 2 μ} Et ) + … + Π ( {Σ}_{t = n - μ}^{n} Et ) ; where μ > 0 is the event time ; = Π ( {E}_{μ} ) + Π ( {E}_{μ} ) + … + Π ( {E}_{μ} ) ; = Π ( {\sum }_{μ = s}^{k μ} E μ ) + Π ( {\sum }_{μ = k μ}^{p μ} E μ ) + … + Π ( {\sum }_{u = p μ}^{n} E μ ) ; = where k > 0 and p > 0 ;$$

In this k-ary tree representation, the whole event Π(E) is the k-ary root node, and the sub-events Π(Σ_{μ=s}^{kμ}Eμ), Π(Σμ=kμ^{pμ}Eμ), Π(Σ_{u=pμ}ⁿEμ) are the k-ary child nodes respectively.

Any event has a natural language consisting of a dictionary and syntax used to predict or describe the outcomes of the event. Let Ω denote the natural language of an event, then we can represent the prediction statements of the event as follows:

$$\prod ( E ) = \prod ( {\sum }_{t = s}^{n} Et ) ;$$

$$Ω [ \prod ( E ) ] = Ω [ \prod ( {\sum }_{t = s}^{n} Et ) ] ; = Ω [ \prod ( {E}_{t = s}^{s + μ} Et ) ] + Ω [ \prod ( {\sum }_{t = s + μ}^{s + 2 μ} Et ) ] + … + Ω [ \prod ( {\sum }_{t = n - μ}^{n} Et ) ] ; = Ω [ \prod ( {E}_{μ} ) ] + Ω [ \prod ( {E}_{μ} ) ] + … + Ω [ \prod ( {E}_{μ} ) ] ; = Ω [ \prod ( {\sum }_{μ = s}^{k μ} E μ ) ] + Ω [ \prod ( {\sum }_{μ = k μ}^{p μ} E μ ) ] + … + Ω [ \prod ( {\sum }_{u = p μ}^{n} E μ ) ] ; where k > 0 and p > 0.$$

Ω[Π(E)] represents the ensemble of natural language prediction statements at the root node (whole event), and Ω[Π(Σ_{μ=s}^{kμ}Eμ)], Ω[Π(Σμ=kμ^{pμ}Eμ)], Ω[Π(Σ_{u=pμ}ⁿEμ)] represent the ensemble of natural language prediction statements at the child nodes (sub-events) respectively.

The User Prediction Statement Generation System segments an event into sub-events recursively using the event discrete time series and represents the event as a k-ary tree with the root node representing the whole event and child nodes representing sub-events respectively. The natural language processing method (NLPM) of the event dictionary and syntax is incorporated at each k-ary tree node to enable users generate valid simple and compound prediction statements at each node of the k-ary tree.

Various systems and methods for prediction statements and betting have been described over the years. The following patents describe the prior art and limitations: U.S. Pat. No. 9,028,323 discloses a “System and method for betting”; U.S. Pat. No. 8,814,660 discloses a “Fantasy betting application and associated methods”; Patent No US20090054127 discloses a “Multi-Stage Future Events Outcome Prediction Game”; Patent No US20110065494 discloses “A system and method for purchasing and trading wagering shares representing one of two possible outcomes of an event before and during the event”. Computer Applications such as PredCred, Stox, Fan Games Arena, BetClan, Winans, and PredictIt disclose various types of prediction and betting systems.

These existing patents and applications are focused on predicting outcomes of an event. This invention is not focused on predicting outcomes of an event, instead it utilizes computerized methods to enable users generate valid event prediction statements.

These existing patents and applications also lack granularity which limits user capabilities to generate prediction statements for the whole event (root node) and progressively through sub-events (child nodes). In fact, most of these patents and applications are statistical or odds-based with limited capabilities for users generated prediction statements.

These existing patents and applications also lack natural language processing methods (NLPM) which present three drawbacks: 1) delimits users to the generation of mostly simple binary prediction statements; 2) absence of a framework to validate user generated prediction statements; 3) requires users to be knowledgeable in the event domain to generate valid prediction statements.

### BRIEF SUMMARY OF THE INVENTION

This invention is a User Prediction Statement Generation System that uses computerized methods and algorithms to segment any event into sub-events utilizing the event discrete time series. The segmented event is represented as a k-ary tree with the root node representing the entire event, the child nodes representing sub-events recursively until sub-events (leaf nodes) with the event unit time. A natural language processing method of the event dictionary and syntax is incorporated at each node of the k-ary tree to ensure user generation of valid prediction statements. Let us demonstrate the functionality of the system with an NFL football game event E.

$$Ω [ \prod ( E ) = Ω [ \prod ( E ) , the whole NFL football game ( root node or level 0 ) ; = Ω [ \prod ( H 1 ) + Ω [ \prod ( H 2 ) ; where H 1 , H 2 are the NFL football game first and second half ( level 1 are child nodes of level 0 ) ; = Ω [ \prod ( E 1 ) + Ω [ \prod ( E 2 ) + Ω [ \prod ( E 3 ) + Ω [ \prod ( E 4 ) ; where E 1 , E 2 , E 3 , E 4 are the NFL football game quarters ( level 2 are child nodes of level 1 ) ; = Ω [ \prod ( {\sum }_{t = 1}^{1} Et ) ] + Ω [ \prod ( {\sum }_{t = 1}^{1} Et ) ] + Ω [ \prod ( {\sum }_{t = 1}^{1} Et ) ] + Ω [ \prod ( {\sum }_{t = 1}^{1} Et ) ] ; t is minute , NFL football quarter is 15 minutes ( level 3 are child nodes of level 2 ) ; = Ω [ \prod ( {\sum }_{s = 1}^{9} Et ) ] + Ω [ \prod ( {\sum }_{t = 1}^{9} Et ) ] + Ω [ \prod ( {\sum }_{s = 1}^{9} Et ) ] + Ω [ \prod ( {\sum }_{s = 1}^{9} Et ) ] ; s is second , NFL football quarter is 900 seconds ( level 4 are child nodes of level 3 ) . The NFL football game is represented by 5 levels ( level 0 to level 4 ) , where users can generate prediction statements at each level or node prior or during the game .$$

A user connects to the system through the Internet using a device, selects an event, and inputs the prediction parameters in one of the three ways below:
a) Directly speak through the device microphone for the system to capture the prediction parameters using voice recognition. The system utilizes the prediction parameters to traverse the event k-ary tree to the appropriate node, and the node natural language processing method parses the prediction parameters to generate a valid user prediction statement. If the prediction parameters are invalid (no possible event outcome), the NLPM suggests similar or possible valid prediction parameters and prompt the user to accept/reject.
b) Keyboard the prediction parameters on the device. The natural language processing method acts as a wizard to ensure input of only valid prediction parameters.
c) Use the system provided navigation methods to traverse the event k-ary tree and the natural language processing method at the node to generate the user prediction statements.

Using the NFL football game as an example, a user can generate simple and compound prediction statements at various levels.

### Examples at the Root Node (Level 0):

Simple: Team-A wins; Team-A scores 30 points; Player-P scores 2 touchdowns.

Compound: Team-A wins if Team-A leads by 2 touchdowns in the first half.

### Examples at the Child Nodes (Level 1):

Simple: Team-A leads in first half; Team-A scores 30 points in first half.

Compound: Team-A wins first half if Player-P has 200 running yards.

The main advantages of this invention are:
1) Real time user generation of simple and compound binary prediction statements for events and sub-events.
2) Granular system for users to generate all possible ensemble of natural language prediction statements for events and sub-events.
3) Natural language processing method (NLPM) to ensure valid user generated prediction statements.
4) Flexible system for creation of prediction statements before or during an event.
5) Open system that integrates with Artificial Intelligence (AI), Digital Signal Processing (DSP), Social Media, Knowledge Base Systems (KBS), Streaming and Marketplace Intelligent Tools to enhance prediction markets and crowdsourcing.

### BRIEF DESCRIPTION OF THE SEVERAL VIEWS OF THE DRAWING

FIG. 1 is the integrated view of this invention;

FIG. 2 is the event k-ary tree representation;

FIG. 3 is the prediction statements schema;

FIG. 4 is a sample NFL event prediction statements schema.

FIG. 5 is the Device/Input Graphical User Interface (GUI)

### DETAILED DESCRIPTION OF THE INVENTION

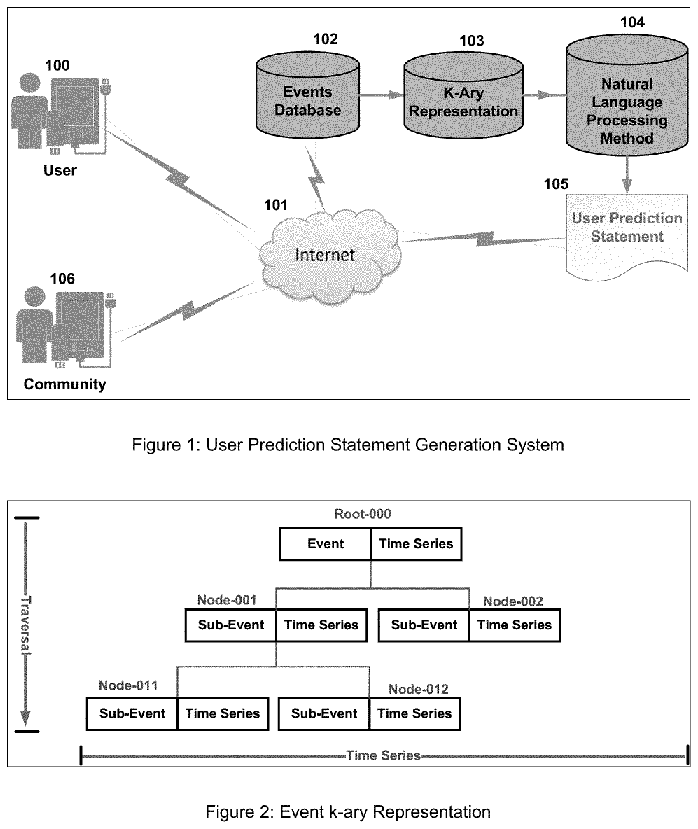

Embodiments depicted in FIGS. 1 to 5 of this invention are described herein with drawings and relevant components, such that those skilled in the art can have an understanding of the system.

FIG. 1 illustrates the embodiment of this innovation consisting of an event database 102; user 100 uses a device to access the event database 102 via the Internet 101; user 100 selects the event from the event database 101 and inputs prediction parameters via voice, keyboard or GUI; the system traverses the event k-ary representation 103 to the appropriate node based on the user prediction parameters; the natural language processing method (NPLM) 104 of the node parses the user prediction parameters to create the user prediction statement 105; the user prediction statement 105 is published through the Internet 101 to the user 100 and user community 106.

FIG. 2 presents a sample k-ary tree representation; Root-000 represents the whole event and duration at level 0; Root-000 is segmented into two sub-events Node-001 and Node-002 and their respective durations at level 1; Node-001 is segmented into two sub-events Node-011 and Node-012 and their respective durations at level 2.

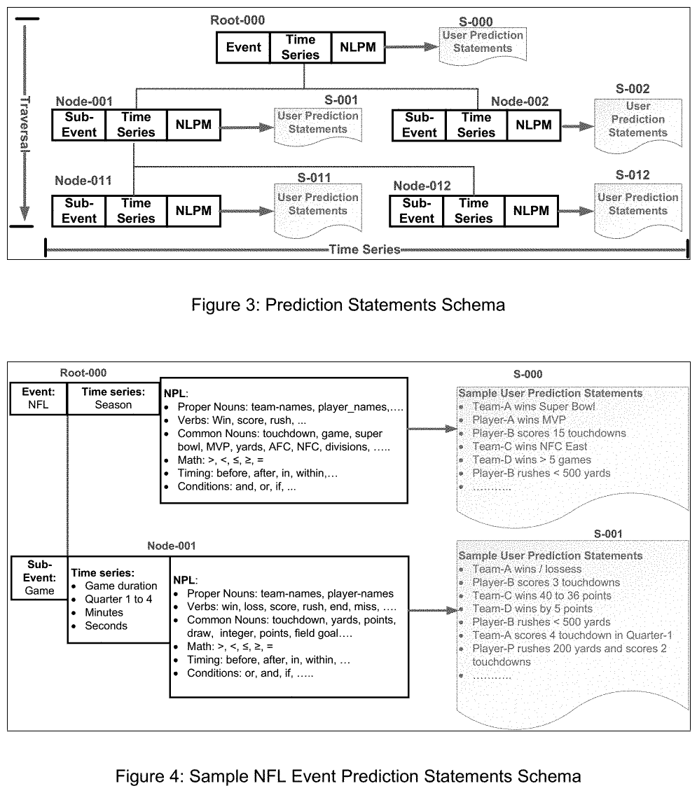

FIG. 3 presents the schema of prediction statements; prediction statements S-000 are generated from the Root-000 [Event, Time-Series, NLPM] at level 0; sub-event prediction statements S-001 and S-002 are generated from Node-001 and Node-002 respectively at level 1; sub-event prediction statements S-011 and S-012 are generated from Node-011 and Node-012 respectively at level 2;

FIG. 4 presents a sample NFL event prediction statements schema; sample NFL season prediction statements S-000 are generated from Root-000 [Event, Time-Series, NLPM]; sample NFL game prediction statements S-001 are generated from Node-001 [Sub-Event, Time-Series, NLPM].

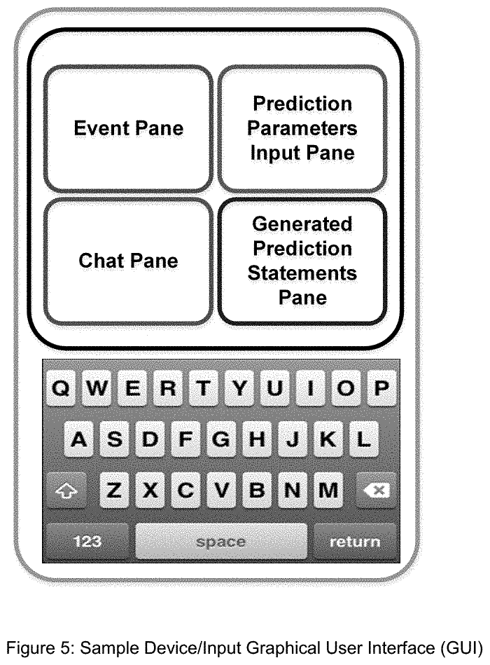

FIG. 5 presents a Device/Input Graphical User Interface (GUI); the event pane display the live event (video, voice, data) using APIs or the description/image of the upcoming event; the prediction parameters input pane is for the user input prediction parameters via voice, keyboard/typing or k-ary GUI; the generated prediction statements pane display the user generated prediction statements, user community (private) and system (public) generated prediction statements with associated user search/sort functions; the chat pane provides online social media tools to communicate/chat with public and private user communities.

What is claimed is:

1. A User Prediction Statement Generation System comprising of:
(A) a computer system to process input data and output results;
(B) a device to input data and display output from the computer system;
(C) an Internet connection with the computer system and device;

2. The computer system of claim 1, wherein said computer system comprises event database, event k-ary tree representation, and natural language processing method;

3. The event database of claim 2, wherein said database comprises functions and computer code library of modules to list events;

4. The event k-ary tree representation of claim 2; wherein the event in claim 3 has been segmented into sub-events using the event discrete time series;

5. The event k-ary tree representation of claim 4; wherein the root node represents the entire event (duration) and child nodes represent sub-events (sub-durations) until the leaf nodes representing sub-events with the event unit time;

6. The natural language processing method of claim 2, wherein such method consist of the event dictionary and syntax of the event domain;

7. The natural language processing method of claim 6, wherein such method is incorporated at each node of the event k-ary tree representation;

8. The device of claim 1, wherein such device accepts user data input and display output from the computer system of claim 2;

9. The device of claim 8, wherein such device accept user prediction parameters via voice, keyboard or k-ary tree GUI;

10. The Internet connection of claim 1; wherein such connection permits the device of claim 8 to communicate with the computer system of claim 1;

11. The communication of claim 10; wherein such communication transmits user prediction parameters of claim 8 to the database of claim 2;

12. The prediction parameters of claim 11; wherein such parameters determine the event from the event database of claim 3;

13. The event of claim 12; wherein such event is segmented and represented as a k-ary tree of claim 4;

14. The prediction parameters of claim 8; wherein such parameters as used to traverse the k-ary tree of claim 13 to the desired tree node;

15. The tree node of claim 14; wherein the natural language method of the node of claim 7 is used to generated the prediction statement

16. The generated prediction statement of claim 15; wherein such statement is transmitted through the internet connection of claim 10 to the device;

17. The device of claim 16; wherein such device displays the prediction statement of claim 15 to the user and community.
